(19) United States
(12) Patent Application Publication
(10) Pub. No.: US 2010/0053613 A1
(43) Pub. Date: Mar. 4, 2010

(54) Rain sensor

(75) Inventor: Tetsuo Taoka, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: NILES CO., LTD., Tokyo (JP)

(21) Appl. No.: 12/461,839

(22) Filed: Aug. 26, 2009

(30) Foreign Application Priority Data
Aug. 28, 2008 (JP) 2008-220314

(51) Int. Cl. G01N 21/47

(52) U.S. Cl. 356/342

(57) ABSTRACT

To improve detection performance without requiring precise positioning of a light-emitting element and a lens, a rain sensor 10 having a light-emitting element 13 for emitting light to a windshield glass G; a light-receiving element 14 for receiving the light reflected from the windshield glass G; and a convex lens 18 provided between the light-emitting element 13 and the windshield glass G, for collimating the light emitted from the light-emitting element 13 into parallel light, in which a collection prism 20 is interposed between the light-emitting element 13 and the convex lens 18 so as to provide, at a focal position for the convex lens 18, a light-exiting surface for the light from the light-emitting element 13 having entered the collection prism 20, in order to collect rays of diffused light emitted from the light-emitting element 13 and then emit the collected rays of the light to the convex lens 18 from the focal position for the convex lens 18.

### TECHNICAL FIELD

The present invention relates to a rain sensor.

### BACKGROUND ART

Japanese Unexamined Patent Application Publication No. 2001-66246, for example, discloses a rain sensor which produces an output in accordance with raindrops stuck to a vehicle's windshield glass.

The rain sensor according to the conventional example disclosed in Japanese Unexamined Patent Application Publication No. 2001-66246 includes a light-emitting element for emitting light to the windshield glass and a light-receiving element for receiving the light reflected from the windshield glass. This rain sensor detects the amount of raindrops based on the amount of light received by the light-receiving element, thereby making a judgment concerning the presence of rain.

FIGS. 5A and 5B are views each schematically showing a positional relation between the light-emitting element and a lens of the rain sensor according to the conventional example. In the rain sensor according to the conventional example disclosed in Japanese Unexamined Patent Application Publication No. 2001-66246, diffused light 103 emitted from a light-emitting element 100 is collimated into parallel light 104 by a lens (convex lens) 101, thereby being emitted to the windshield glass, not shown.

In order to ensure that the light-receiving element receives the light reflected from the windshield glass, as shown in FIG. 5A, it is necessary that the light-emitting element 100 emit light to the lens 101 from a focal position F of the lens 101 and that the diffused light 103 from the light-emitting element 100 be collimated by the lens 101 into the parallel light 104 along a predetermined optical path L. This is because an entry angle of diffused light 103A on the lens 101 is changed in a case where a position at which the light-emitting element 100 emits light is displaced from the focal position F for the lens 101, as shown in FIG. 5B. In this case, light 104A passed through the lens 101 is not collimated into parallel light and thus, the light-receiving element fails to receive light which is supposed to reach the light-receiving element, thereby decreasing detection performance of the rain sensor.

For the reasons stated above, the conventional rain sensor requires precise positioning between the light-emitting element and the lens at the time of manufacture. Thus, there has been a problem that positioning becomes very difficult in a case of a rain sensor which employs a light-emitting element of a plane-mounting type for the purpose of cost reduction.

### DISCLOSURE OF THE INVENTION

It is an object of the present invention to provide a rain sensor improved in its detection performance without requiring the precise positioning between the light-emitting element and the lens.

A rain sensor according to the present invention, which includes: a light-emitting element for emitting light to a windshield glass; a light-receiving element for receiving the light reflected from the windshield glass; and a lens provided between the light-emitting element and the windshield glass, for collimating the light emitted from light-emitting element, into parallel light, is configured as follows. A collection prism is interposed between the light-emitting element and the lens so as to provide, at a focal position for the lens, a light-exiting position for the light from the light-emitting element having entered the collection prism.

According to the present invention, the light which has been emitted from the light-emitting element and entered the collection prism is emitted to the lens from the focal position for the lens. Thus, the precise position between the light-emitting element and the lens is not required at the time of manufacture as long as the light-emitting element is provided at a position from which the emitted light can enter the collection prism. Further, the light having entered the collection prism is caused to exit from the focal position for the lens toward the lens, thereby being collimated into parallel light. Therefore, unlike the conventional device, inclination of an optical axis due to displacement of the light-emitting element does not occur. As a result, variations in output performance of manufactured rain sensors can be reduced.

### BRIEF DESCRIPTION OF DRAWINGS

FIG. 1 is a view illustrating a structure of a rain sensor according to an embodiment.

FIG. 2 is an enlarged view showing an essential part of the rain sensor according to the embodiment.

FIGS. 3A and 3B are views each showing a collection prism.

FIG. 4 is a view illustrating a modified example of a position at which a light-emitting element is disposed.

FIGS. 5A and 5B are views each illustrating a positional relation between a light-emitting element and a lens in a rain sensor according to a conventional example.

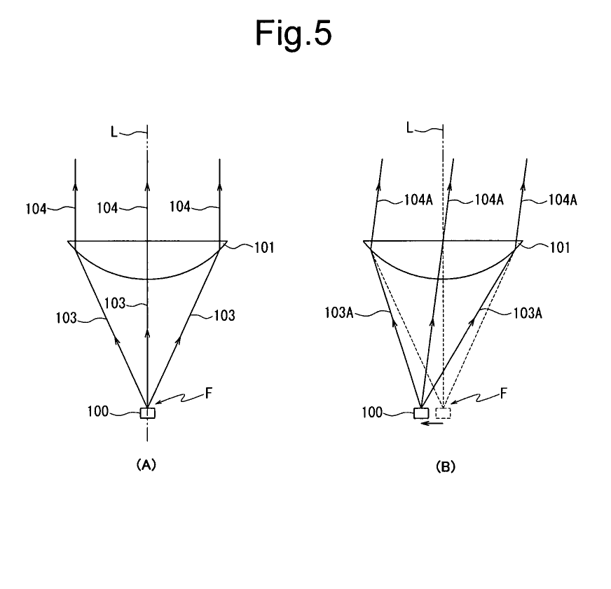

### DESCRIPTION OF THE INVENTION

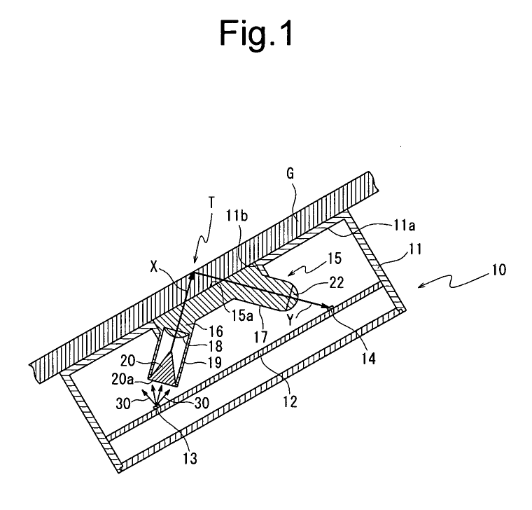

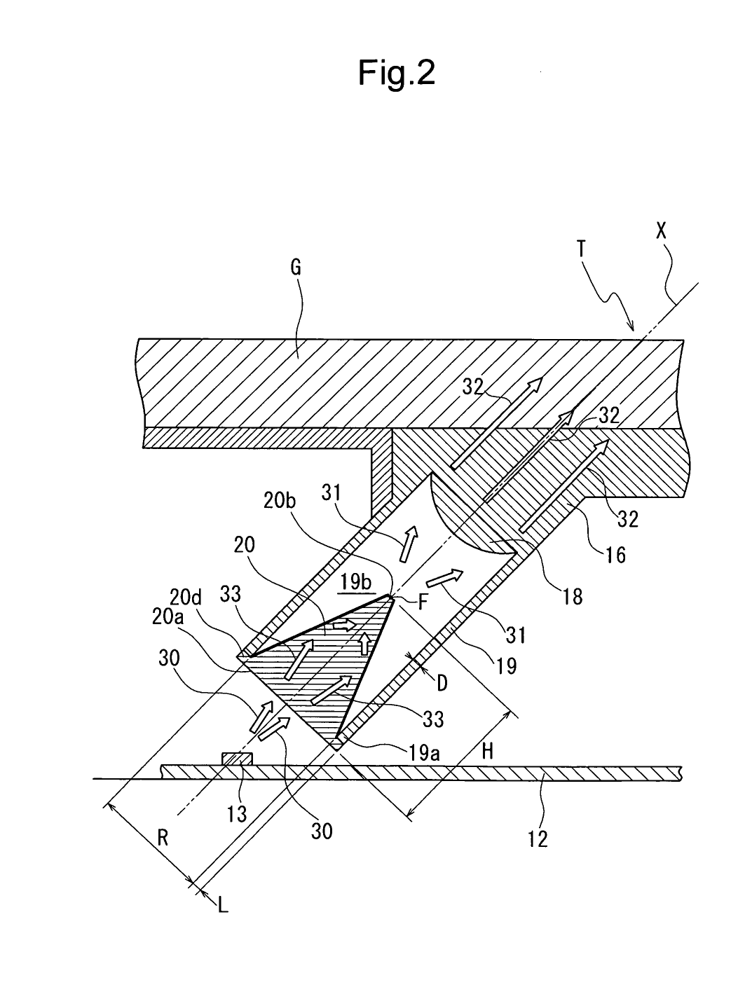

Hereinafter, an embodiment of the present invention will be described. FIG. 1 is a view for illustrating a structure of a rain sensor according to the embodiment, in which a windshield glass G attached with a rain sensor 10 is viewed in a cross-sectional direction. FIG. 2 is an enlarged view schematically showing an essential part at a side of a lead-in part 16 of the rain sensor 10.

The rain sensor 10 is secured to a surface of the windshield glass G at a vehicle interior side, by means of an adhesive agent or sheet, not shown. A printed substrate 12 parallel to the windshield glass G is provided inside a box-shaped main body case 11 of the rain sensor 10. A light-emitting element 13 and a light-receiving element 14 are disposed on a top surface of the printed substrate 12 at a side of the windshield glass G.

The light-emitting element 13 is made up of, e.g., an LED, and emits light (diffused light) 30 to the upper side of the windshield glass G The light-emitting element 13 is provided at a position from which at least part of the diffused light 30 having been emitted can enter a bottom surface 20a of a collection prism 20.

The light-receiving element 14 receives part of the light emitted from the light-emitting element 13, namely the part having been reflected from a detection region T of the windshield glass G, and provides a current value in proportion to the amount of received light (received light amount). The detection region T has a predetermined area and is located within a region wiped by a windshield wiper of the windshield glass G.

When droplets or the like are stuck to the detection region T, the light emitted from the light-emitting element 13 to the detection region T is diffused by the droplets. Therefore, the amount of light that reaches the light-receiving element 14 is changed in accordance with the droplets stuck to the detection region T, and an output value (current value) of the light-receiving element 14 is changed in accordance with the received light amount. Thus, in the rain sensor 10, a judgment part, not shown, makes a judgment on the presence of rain by determining the amount of droplets stuck to the detection region T based on variation in output values of the light-receiving element 14.

A bottom wall 11a of the main body case 11 is provided with an opening 11b through which an attachment surface 15a of a prism 15 at a side of the windshield glass G is exposed. The attachment surface 15a of the prism 15 is secured to a surface of the windshield glass G at the vehicle interior side, inside the opening 11b of the bottom wall 11a, by means of, e.g., an optically-transparent adhesive agent or sheet, not shown.

The prism 15 is interposed between (i) the light-emitting element 13 and the windshield glass G and (ii) the light-receiving element 14 and the windshield glass G, and includes the lead-in part 16 for guiding the light emitted from the light-emitting element 13, into the detection region T of the windshield glass G; and a lead-out part 17 for guiding the light reflected from the detection region T toward the light-receiving element 14.

Hereinafter, the prism 15 will be described in detail. The lead-out part 17 is provided along an optical path Y extending from the detection region T of the windshield glass G to the light-receiving element 14. The lead-out part 17 has a distal end provided with a convex lens 22 in a semispherical shape, on the printed surface 12 side. The convex lens 22 is made from the same material as the lead-out part 17, and is formed to be united therewith. The light-receiving element 14 is located at the focal position for the convex lens 22 so that rays of the light (parallel light), which has been reflected from the windshield glass G and passed inside the lead-out part 17 to the printed substrate 12 side, are collected by the convex lens 22 and thus received by the light-receiving element 14.

As shown in FIG. 2, the lead-in part 16 is provided along an optical path X extending from the light-emitting element 13 side to the detection region T. The lead-in part 16 has a distal end provided with a convex lens 18 in a semispherical shape, at the printed substrate 12 side. The convex lens 18 is made from the same material as the lead-in part 16, and is formed to be united therewith. Diffused light 31 from the light-emitting element 13 side, which has entered the convex lens 18, is collimated by the convex lens 18 into parallel light 32 along the optical path X and then passes through the inside of the lead-in part 16, thereby being emitted to the detection region T.

The lead-in part 16 is provided with a holder 19 in a cylindrical shape projecting along the optical path X toward the printed substrate 12 side. The holder 19 is made from the same material as the lead-in part 16, and is formed to be united therewith. The holder 19 has a distal end 19a at the printed substrate 12 side, in contact with a flange part 20d of the collection prism 20 inserted into the holder 19.

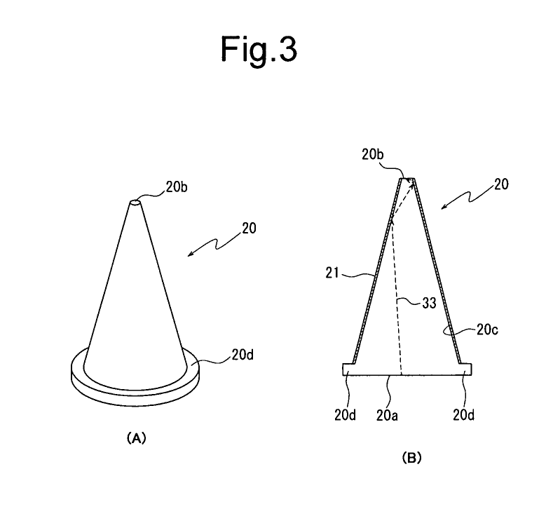

The collection prism 20 is made from transparent glass or resin and has a conical shape, as shown in FIG. 3A. As shown in FIG. 3B, a bottom surface 20a of the collection prism 20 is set as a light-entrance surface that the diffused light emitted from the light-emitting element 13 enters. The apex side of the collection prism 20 is cut off in parallel to the bottom surface 20a to form a flat surface 20b with a very small area, resulting in the collection prism 20 having a frusto-conical shape. The flat surface 20b of the collection prism 20 is set as a light-exiting surface for the light having entered the collection prism 20.

A peripheral surface 20c of the collection prism 20 is entirely coated with a reflection film 21 made of metal material such as aluminum or silver by the conventionally-known metal vapor deposition method. An inner surface of the reflection film 21 at the collection prism 20 side functions as a reflection mirror, so that the light having entered the collection prism 20 from the bottom surface 20a proceeds inside the collection prism 20 by repeated reflection from the reflection film 21, and then exits from the flat surface 20b after passing through the path indicated by numeral 33.

A periphery of the bottom surface 20a of the collection prism 20 is entirely provided in a circumferential direction with the flange part 20d which is radially-outwardly projecting. As shown in FIG. 2, a projecting length L of the flange part 20d is equal to a thickness D of the holder 19, and the flange part 20d is adhered and secured to the distal end 19a of the holder 19 at the printed substrate 12 side.

A diameter R of the bottom surface 20a of the collection prism 20, not including the flange part 20d, is equal to an inner diameter of a space 19b inside the holder 19. The collection prism 20 is secured by being fit into the holder 19, in a state in which the flat surface 20b faces the convex lens 18 while the bottom surface 20a faces the printed substrate 12 between the light-emitting element 13 and the convex lens 18.

The collection prism 20 fit into the holder 19 is provided such that a virtual line extending between the apex of the collection prism 20 and the center of the bottom surface 20a corresponds with the optical path X for the light emitted to the detection region T. Thus, the flat surface 20b serving as a light-exiting surface for the light having entered the collection prism 20 is disposed on the optical path X. Further, a height H of the collection prism 20 is set such that the flat surface 20b is disposed at the focal position F for the convex lens 18 when the collection prism 20 is supported by being inserted into the holder 19. Thus, the light having entered the collection prism 20 is emitted to the convex lens 18 from the focal position F for the convex lens 18.

In the rain sensor 10 having the above-described structure, rays of light 33 having entered the collection prism 20, which are part of the diffused light 30 emitted from the light-emitting element 13, are collected while proceeding inside the collection prism by repeated reflection from the reflection film 21. Thereafter, the light 33 is emitted to the convex lens 18 from the flat surface 20b situated at the focal position F for the convex lens 18. Thus, the light having entered the convex lens 18 is collimated by the convex lens 18 into the parallel light along the predetermined optical path X, and then emitted to the detection region T of the windshield glass G

As described above, in this embodiment, the rain sensor 10 having the light-emitting element 13 for emitting light to the windshield glass G; the light-receiving element 14 for receiving the light reflected from the windshield glass G; and the convex lens 18 provided between the light-emitting element 13 and the windshield glass G, for collimating the light emitted from the light-emitting element 13 into the parallel light, is configured as follows. The collection prism 20 is interposed between the light-emitting element 13 and the convex lens 18 so as to provide at the focal position F for the convex lens 18, the flat surface 20b serving as the light-exiting surface for the light having entered the collection prism 20 from the light-emitting element 13. In this manner, the light having been emitted from the light-emitting element 13 is emitted to the convex lens 18 from the collection prism 20 having a light-emitting position at the focal position F for the convex lens 18. Therefore, precise positioning of the light-emitting element 13 and the convex lens 18 is not required at the time of manufacture as long as the light-emitting element 13 is provided at the position from which the emitted light can enter the collection prism 20. In this manner, the manufacturing process is simplified, thereby achieving reduced manufacturing cost. Further, the degree of freedom for the position of the light-emitting device 13 is increased, thereby increasing the degree of freedom for design of the printed substrate 12. Further, the light having entered the collection prism 20 is emitted to the convex lens 18 from the focal position F for the convex lens 18, thereby being collimated by the convex lens 18 into the parallel light. This ensures that the light-receiving element 14 receives the light reflected from the detection region T. Thus, unlike the device according to the conventional example, inclination of an optical axis due to displacement of the light-emitting element does not occur. Further, fluctuations in the optical axis due to variations in mechanical dimensions at the time of manufacture can be reduced. Therefore, variations in output performance of manufactured rain sensors can be reduced, thereby improving output stability, leading to reduction in causes for malfunction in the rain sensor 10.

The collection prism 20 has a conical shape configured as follows. The bottom surface 20a is set as the light-entrance surface for the light emitted from the light-emitting element 13. The flat surface 20b, which is formed by cutting off the apex side in parallel to the bottom surface 20a, is set as the light-exiting surface for the light having entered the collection prism 20. The conical surface of the collection prism 20 is entirely coated with the reflection film 21. The bottom surface 20a of the collection prism 20 having a conical shape is set as the light-entrance surface, resulting in a large light-entrance surface. This enables more rays of the diffused light emitted from the light-emitting element 13 to be emitted to the detection region T and used for detection of raindrops. As a result, the amount of light received by the light-receiving element 14 is increased, thereby increasing strength of the signal output by the light-receiving element 14, leading to improvement in the detection performance of the rain sensor 10. Further, since the conical surface of the collection prism 20 is entirely coated with the reflection film 21, rays of the light having entered the collection prism 20 from the bottom surface 20a serving as the light-entrance surface proceed inside the collection prism 20 by repeated reflection from the reflection film 21 and are collected on the flat surface 20b serving as the light-existing surface, thereby being emitted to the convex lens 18. Further, the amount of light received by the light-receiving element 14 is increased, and thus, strength of the signal output by the light-receiving element 14 is increased, so that the detection performance of the rain sensor 10 is improved. Yet further, the flat surface 20b is situated at the focal position F for the convex lens 18, so that ideal parallel light can be obtained without being affected by displacement of the light-emitting element 13, thereby being emitted to the detection region T.

The rain sensor 10 according to the present invention further includes the holder 19 in a cylindrical shape projecting from a peripheral edge of the convex lens 18 to the light-emitting element 13 side so that the collection prism 20 in a conical shape is supported by the holder 19. In a case where the collection prism 20 is formed by fitting a base distal end of the flange part 20d into the holder 19 having a cylindrical shape, the flat surface 20b situated at the apex side of the collection prism 20 is positioned at the center of the space 19b inside the holder 19 when viewed in a cross-sectional direction. Thus, the flat surface 20b can be accurately disposed at the focal position F for the convex lens 18 merely by setting the height H of the collection prism 20.

The above-described embodiment employs the collection prism 20 having the flat face 20b formed by cutting off the apex side of the conical shape in parallel to the bottom surface 20a, so as to set the flat surface 20b at the apex side as the light-emitting surface for the light having entered the collection prism 20. However, a collection prism may be employed in which the apex side is not cut off and only a small part including the apex and the vicinity thereof is not coated with the reflection film so as to emit the light to the convex lens 18 from the part (apex) not coated with the reflection film. This case also produces similar effects as those of the above-described embodiment. Further, this case allows the process of forming the flat surface 20b to be omitted, thereby further reducing the manufacturing cost

The above-described embodiment has described the case with the flat bottom surface 20a of the collection prism 20, serving as the light-receiving surface for the light emitted from the light-emitting element 13. However, this bottom surface 20a may be formed in a shape such as the convex lens 18 having a semispherical shape projecting to the printed substrate 12 side. In this case, an optical path for light having entered the bottom surface in the convex-lens shape, which is part of the diffused light emitted from the light-emitting device 13, is adjusted, so that the light can be easily guided to the flat face 20b side of the collection prism 20.

The above-described embodiment has described the case in which the collection prism 20 is formed in a frusto-conical shape in which the apex side is cut off in parallel to the bottom surface 20a. However, various cone shapes such as a polygonal pyramid shape may be employed as long as the collection prism 20 is provided at the apex side with the flat surface serving as the light-exiting surface such that rays of the light having entered from the bottom part are collected toward the flat surface.

The above-described embodiment has described the case in which the holder 19 and the convex lens 18 are formed to be united with the lead-in part 16 of the collection prism 20, but these components may be formed independently.

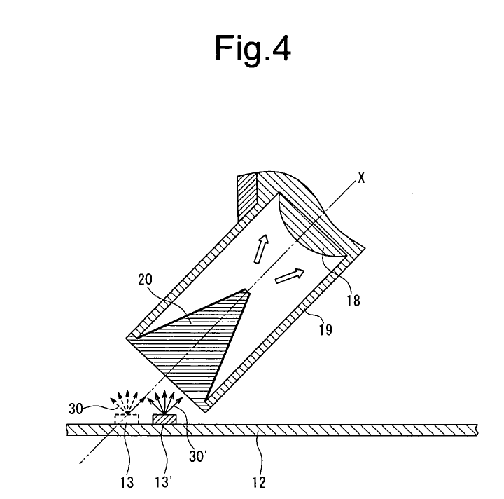

The above-described embodiment has described the case in which the light-emitting element 13 is provided on the predetermined optical path X. The light-emitting element 13 may be provided at a position offset from the optical path X in the direction of the convex lens 18 so that more rays of the diffused light having been emitted enter the collection prism 20, for example, as indicated by numeral 13′ in FIG. 4, as long as the light-emitting element 13 is provided at a position from which the emitted light can enter the collection prism 20. In this case, more rays of the diffused light can enter the collection prism 20, so that the emitted light can be used to detect raindrops even where a diffusion angle of the light emitted from the light-emitting element 13 is large. Therefore, output of the light-receiving element 14 is enhanced, thereby improving the detection performance of the rain sensor.

1. A rain sensor comprising:
a light-emitting element for emitting light to a windshield glass;
a light-receiving element for receiving the light reflected from the windshield glass; and
a lens provided between the light-emitting element and the windshield glass, the lens for collimating the light emitted from the light-emitting element into parallel light, wherein:
a collection prism is interposed between the light-emitting element and the lens; and
a light-exiting surface for the light from the light-emitting element, the light having entered the collection prism, is provided at a focal position for the lens.

2. The rain sensor according to claim 1, wherein:
the collection prism has a cone shape;
a bottom surface of the cone is set as a light-entrance surface for the light, and the light-exiting surface is provided at an apex side of the cone; and
a circumferential surface of the cone is entirely coated with a reflection film;

3. The rain sensor according to claim 1, further comprising a holder having a cylindrical shape projecting from a peripheral edge of the lens toward the light-emitting element, wherein the collection prism is supported by the holder.

4. The rain sensor according to claim 2, wherein the cone is set as a conical shape.

5. The rain sensor according to claim 2, further comprising a holder having a cylindrical shape projecting from a peripheral edge of the lens toward the light-emitting element, wherein the collection prism is supported by the holder.

6. The rain sensor according to claim 3, wherein the cone is set as a conical shape.
